(19) United States
(12) Patent Application Publication
(10) Pub. No.: US 2026/0079323 A1
(43) Pub. Date: Mar. 19, 2026

(54) WEARABLE DISPLAY DEVICE

(71) Applicant: Apple Inc., Cupertino, CA (US)

(72) Inventors: Alexander B von Schulmann, Sunnyvale, CA (US); Matin Seadat Beheshti, Sunnyvale, CA (US); Trevor S Chambers, San Diego, CA (US)

(21) Appl. No.: 19/064,055

(22) Filed: Feb. 26, 2025

Related U.S. Application Data
(60) Provisional application No. 63/696,288, filed on Sep. 18, 2024.

(51) Int. Cl. G02B 7/12; G02B 27/01

(52) U.S. Cl. CPC G02B 7/12; G02B 27/0176; G02B 2027/0154

(57) ABSTRACT

A wearable display device can include a display frame, a first lens coupled to the display frame, a second lens coupled to the display frame, and a detent mechanism. The detent mechanism can include a body, with the body defining a first cavity and a second cavity radially spaced about a circumferential surface of the body, and a detent configured to engage with at least one of the first cavity or the second cavity. The wearable display device can further include a first rail movably coupled to the body, with the first rail coupled to the first lens, and a second rail movably coupled to the body, with the second rail coupled to the second lens.

### CROSS-REFERENCE TO RELATED APPLICATIONS

This claims priority to U.S. Provisional Ser. No. 63/696,288 , filed 18 Sep. 2024, and entitled “WEARABLE DISPLAY DEVICE,” the entire disclosure of which is hereby incorporated by reference.

### FIELD

The present disclosure relates generally to wearable display devices. More particularly, the present disclosure relates to an adjustment system for wearable display devices.

### BACKGROUND

Various components of wearable display devices, such as head-mountable displays (HMD), can include as display screens, viewing frames, securement arms, speakers, batteries, waveguides, and other components, which operate together to provide an immersive experience. User's heads vary in size and shape, and more specifically the distance between a user's eyes, otherwise known as interpupillary distance (IPD), can vary from user to user. Display screens or display lenses provide the most optimal immersive experience when the lenses are positioned directly in front of the user's eyes. However, many lenses in HMD's can be difficult to adjust and properly position in front of the user's eyes Therefore, there is a need for an HMD with an effective and simple-to-use an adjustment system to position the lenses in front of the user's eyes.

### SUMMARY

At least one example of the present disclosure includes a wearable display device including a display frame, a first lens coupled to the display frame, a detent mechanism having a body defining a first cavity and a second cavity radially spaced about a circumferential surface of the body and a detent configured to engage with at least one of the first cavity or the second cavity, a first rail movably coupled to the body, the first rail coupled to the first lens, and a second rail movably coupled to the body, the second rail coupled to the second lens.

In one example, the body defines a cam surface between the first cavity and the second cavity. In one example, the cam surface includes a higher coefficient of friction relative to the first cavity and the second cavity. In one example, the cam surface includes an elastomer material. In one example, the body includes at least one of a polymer, a carbon-steel, or a ceramic. In one example, the wearable display device further includes an encoder configured to determine a position of the body. In one example, the wearable display device further includes a pin coupled to the body and the body is configured to rotate relative to the pin. In one example, the first rail and the second rail are configured to translate symmetrically relative to the body. In one example, the detent includes at least one of a spring-loaded ball, a plunger, a roller, or a flexure. In one example, the first cavity and the second cavity include at least one of a pin, a triangle, or a scallop shape. In one example, the first cavity includes an asymmetric profile to provide different feedback based on a direction of travel of the body.

In at least one example of the present disclosure, a wearable display device includes a display frame, a first lens coupled to the display frame, a second lens coupled to the display frame, a detent mechanism having a body including a planar outer surface defining a first cavity and a second cavity and a detent configured to engage with at least one of the first cavity or the second cavity, the detent mechanism movable into a first detent position and a second detent position, a pin coupled to the body, the body configured to rotate relative to the pin, a first rail movably coupled to the body, the first rail coupled to the first lens, and a second rail movably coupled to the body, the second rail coupled to the second lens.

In one example, when the detent is in a first detent position engaged with the first cavity, the detent secures the body in a first body position and the body in the first body position secures the first rail and the second rail in a first rail position, the first rail and the second rail in the first rail position secures the first lens and the second lens in a first lens position defined by a first width, when the detent is in a second detent position engaged with the second cavity, the detent secures the body in a second body position and the body in the second body position secures the first rail and the second rail in a second rail position, and the first rail and the second rail in the second rail position secures the first lens and the second lens in a second lens position defined by a second width. In one example, the wearable display device further includes a magnet coupled to the body. In one example, the wearable display device further includes a magnet array disposed radially about the body, the magnet array configured to be used to determine a position of the body.

In at least one example of the present disclosure, a wearable display device includes a display frame, a lens coupled to the display frame, a lens adjustment mechanism including a body movably coupled to the lens and defining a first cavity, a second cavity, and a cam surface extending between the first cavity and the second cavity. The cam surface can have a higher coefficient of friction relative to the first cavity and the second cavity. The wearable display device can further include a detent configured to engage with at least one of the first cavity, the second cavity, or the cam surface and a pin coupled to the body, the body configured to rotate relative to the pin.

In one example, the cam surface includes an elastomer material such that the cam surface is configured to increase resistance to a sliding force between the cam surface and the detent relative to the first cavity and the second cavity. In one example, the first cavity and the second cavity include a geometry configured to resist the detent from disengaging with the first cavity and the second cavity. In one example, the wearable display device further includes a Hall effect sensor. In one example, the Hall effect sensor is configured to determine a position of the body.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A illustrates a perspective view of one example of a wearable display device and a detent mechanism;

FIG. 1B illustrates a perspective view of one example of a wearable display device and a detent mechanism in a first position;

FIG. 1C illustrates a perspective view of one example of a wearable display device and a detent mechanism in a second position;

FIG. 2A illustrates a perspective view of one example of a wearable display device and detent mechanism;

FIG. 2B illustrates a side view of one example of a detent mechanism;

FIG. 2C illustrates a perspective view of one example of a detent mechanism;

FIG. 3 illustrates a perspective view of one example of a body of a detent mechanism;

FIG. 4A illustrates an example of cavities for a detent mechanism;

FIG. 4B illustrates an example of cavities for a detent mechanism;

FIG. 4C illustrates an example of cavities for a detent mechanism;

FIG. 5 illustrates a perspective view of one example of a detent mechanism;

FIG. 6A illustrates a perspective view of one example of a detent mechanism in a first position; and FIG. 6B illustrates a perspective view of one example of a detent mechanism in a second position.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described embodiments as defined by the appended claims.

The present disclosure generally relates to electronic devices. More particularly, the present disclosure relates to wearable display devices. In at least one example, a wearable display device can include a display frame and a securement arm extending from the frame. Examples of head-mountable devices can include optical devices, for example glasses lenses, goggles with lenses, transparent display windows, display screens or virtual/augmented reality devices that can include optical components. In these examples, the head-mountable device can be donned on the head of a user such that optically transparent widows, for example lenses and transparent optical displays, can be positioned in front of a user's eyes. User's heads can vary in size and shape, and more specifically the distance between a user's eyes, otherwise known as interpupillary distance (IPD), can vary from user to user. Display screens or display lenses provide the optimal immersive experience when the lenses are positioned directly in front of the user's eyes. However, the adjustment of the lenses to match a user's IPD can be difficult as small adjustments to the lens of the wearable display devices can affect the immersive experience delivered to the user.

Current wearable display devices can include an adjustment system that can adjust the position of the lenses for a user. The current wearable display devices can adjust the lenses, but the adjustment mechanisms do not allow for a symmetrical adjustment of the lens and for precise adjustment of the lens of the wearable display device. The IPD adjustment mechanisms described herein are designed to symmetrically adjust the lenses of the device and to accommodate to any variety of users and users of any capability. The adjustment mechanisms can include features providing tactile feedback to the user as well as smooth, fine adjustments. The detent mechanisms described herein can increase the users feel and feedback during adjustments, such that the user can precisely adjust the lens positioning for the user's specific eyes and IPD so the wearable display device can deliver an immersive experience to the user.

In at least one example, the wearable display device can include a display frame with a first lens and a second lens coupled to the display frame, and a detent mechanism. The detent mechanism can allow for the user to symmetrically adjust a distance between the first lens and the second lens to properly align the lenses of the wearable display device to the width of the user's eyes or the IPD of the user. In this way, the displays can properly focus and give the best sense of image depth, 3D effects, and other display features providing immersive alternate and virtual reality experiences from the wearable display device, and the wearable display device can accommodate to any user's head and eyes. In one example, the detent mechanism can include a body, the body can define a first cavity and a second cavity. The detent mechanism can further include a detent configured to engage with at least one of the first cavity or the second cavity. The wearable display device can include a first rail coupled to the body, the first rail can be coupled to the first lens, and a second rail can be movably coupled to the body, with the second rail coupled to the second lens. The engagement of the detent and the cavities of the body as the user rotates the body can provide the tactile feedback and fine adjustments noted above.

In one example, the wearable display device can further include a pin coupled to the body, such that the body can rotate about the pin. In this way, as the body rotates about the pin, the first rail and the second rail can translate inward to close the width between the first lens and the second lens or translate outward to extend the width between the first lens and the second lens. The first rail and the second rail can translate symmetrically, for example, a first lens extending outward, and the second lens extends outward away from one another. This can be advantageous to a user for manipulating just one of the first lens or the second lens to simultaneously adjust the first lens and the second lens. In addition, because small differences in IPD versus lens distance can affect the visual experience, adjusting both lenses simultaneously enables consistent adjustment between the two, rather than having the user adjust both lenses separately and increasing the opportunity for error. In this way, the symmetrical translation of the first lens and the second lens can ensure easy and precise adjustments for the user.

In current wearable devices with adjustment mechanisms, the adjustment mechanism can have a plurality of cavities with a short range of travel between the cavities that can be difficult for a user to move one increment at a time. A users hands motor controls can have a difficult time feeling the mechanism moving one increment at a time and can therefore increase the difficulty of properly aligning the lens of a wearable display device to the user's IPD. The present disclosure includes the cam surface such that the cam surface can slow the detent down while translating from the first cavity to the second cavity and provide a feel and feedback to a user to indicate to the user when the mechanism is translating one increment as a time as to increase the precision of adjustably. Thus, in one example of IPD adjustment mechanisms described herein, the body of an adjustment mechanism can define a cam surface between a first cavity and the second cavity. In this example, the cam surface can be configured to include a higher coefficient of friction relative to the first cavity and the second cavity. For example, the cam surface can include an elastomer material such that the cam surface can be configured to resist a sliding force between the cam surface and the detent as the body rotates about the pin and the detent translates from the first cavity to the second cavity. In this way, the detent mechanism can provide the user a tactile feedback such that the user can determine when the detent has translated from the first cavity to the second cavity. The present disclosure relates to the use of a symmetrical detent mechanism in a HMD and adjustment of lens, however, the system can be used to adjust the straps of an HMD, to adjust a face track, to be a cable management system, or any other suitable configuration that requires an adjustment of distance or orientation between components.

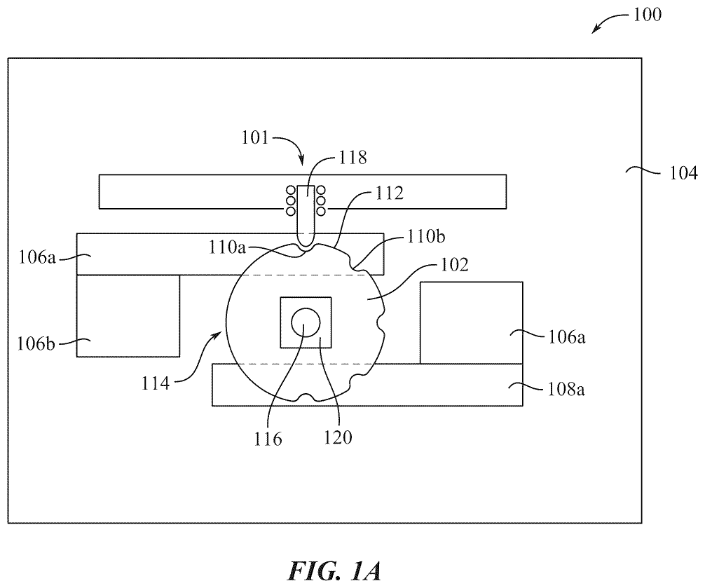

These and other embodiments are discussed below with reference to FIG. 1-6B. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A illustrates a perspective view of one example of a wearable display device 100 and a detent mechanism 101. The wearable display device 100 can be a head-mountable device (HMD) or can be any device or system configured to be worn on the head of a user, such as an optical device, smart glasses, alternate/virtual reality goggles, and the like. As shown in FIG. 1A, the device 100 can include at least one display frame 104 which can house a variety of components and systems. In at least one example, the display frame 104 can be configured to secure a display window, display screen, and/or lenses configured to present visual information to the user. In one example of the present disclosure, the wearable display device 100 can include a first lens 106a coupled to the display frame 104 and a second lens 106b coupled to the display frame 104. The first and second lenses 106a-b, and other lenses shown in other figures and described herein, can include transparent windows without corrective vision properties. The lenses described herein can also include corrective vision features. The lenses described herein can be configured next to displays to transmit and/or direct light from the displays to the eyes of the user. While lenses 106a-b are used as an example in the present disclosure to describe interpupillary adjustments, the lenses 106a-b can be one of a number of components of a display assembly including other components noted above, for example display screens, display support structures, and so forth. Thus, the adjustment in positions of the lenses 160a-b shown and described herein can also apply to the adjustment of any other display assembly components, including displays and so forth. In one or more examples, the first and second lenses 106a, 106b can include optically transparent display windows, display screens, transparent material, optical lenses, or transparent display screens, or combinations thereof, in front of the eyes of the user. As illustrated in FIG. 1A, the wearable display device 100 can further include a first rail 108a coupled to the first lens 106a and can further include a second rail 108b coupled to the second lens 106b.

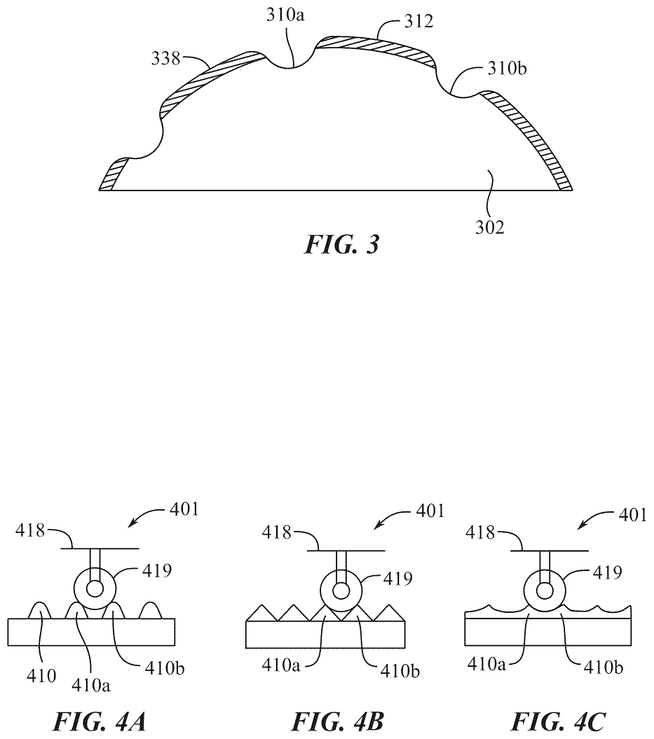

In one example, the wearable display device 100 can further include a detent mechanism 101. The detent mechanism 101 can include a body 102. The body 102 can define a first cavity 110a and a second cavity 110b. In one example, the first and second cavities 110a, 110b can define at least one of a pin, a triangle, or a scallop shape, as illustrated in FIG. 5, discussed in more detail below. As illustrated in FIG. 1A, the body 102 can define a first cavity 110a and a second cavity 110b and a plurality of other cavities defined around the perimeter of the body 102. In one example, the cavities can be defined by and positioned across a quarter of the perimeter of the body 102, a half of the perimeter of the body 102, or around the entirety of the perimeter of the body 102, or any other suitable configuration of the body 102 defining the cavities. As illustrated in FIG. 1A, the body 102 can define a circumferential surface 114 and the first cavity 110a and the second cavity 110b can be spaced out radially about the circumferential surface 114. In one example, the body can include at least one of a polymer, a carbon-steel, or a ceramic. The wearable display device 100 can further include a pin 116. In this way, the body 102 can rotate relative to the pin 116. Although illustrated as a circular body 102 in FIG. 1A, the body 102 can define any suitable shape in one or more other examples. For example, the body 102 can be a linear rail as to translate linearly rather than rotate about a pin 116. As illustrated in FIG. 1A, the first rail 108a can be coupled to the body 102 and the second rail 108b can be coupled to the body 102. The first rail 108a and the second rail 108b can be configured to translate symmetrically relative to the body 102 as the body rotates about the pin 116.

In the illustrated example of FIG. 1A, the body 102 can engage rails 108a-b coupled to display components (e.g., lenses 106a-b) such that when the body 102 rotates about the pin 116, the rails move linearly to adjust the positions of the attached display components. In one example, the body 102 includes gear teeth engaging corresponding gear teeth of the first and second rails 108a-b, for example at the dotted line portions of the rails 108a-b illustrated in FIG. 1A. Other physical engagements, which cause the rails 108a-b to move when the body 102 rotates, can include friction engagements, magnetic engagements, and so forth.

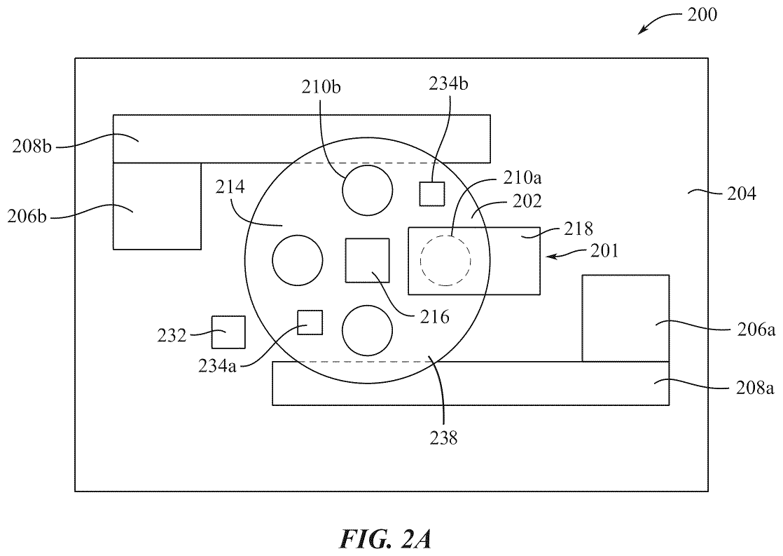

The body 102 can further define a cam surface 112 between the first cavity 110a and the second cavity 110b. The cam surface 112 can be configured to a higher coefficient of friction relative to the first cavity 110a and the second cavity 110b, as illustrated in FIG. 3, discussed in more detail below. The wearable display device 100 can further include a detent 118 configured to engage with at least one of the first cavity 110a, the second cavity 110b, or the cam surface 112. The detent 118 can include at least one of a spring-loaded ball, a plunger as illustrated in FIG. 1A, or a flexure. In one example, the detent 118 can include of a carbon steel, a polymer, a ceramic, or any suitable material. As illustrated in FIG. 1A, the detent 118 can be a plunger with a spring mechanism allowing the detent 118 to translate up and down to engage and disengage with a cavity, such as the first cavity 110a and the second cavity 110b.

The first and second cavities 110a, 110b can be configured to have a geometry to have some resistance to the detent 118 disengaging from the first and second cavities 110a, 110b. In this way, the first and second cavities 110a, 110b can define steeper or lower pitch angles so as to change the difficulty of engaging and disengaging the detent 118. In one example, the first and second cavities 110a, 110b can define asymmetric profiles to provide different feedback based on a direction of travel of the body 102. In this way, it can the pitch angle of the cavity can be increased to increase the difficultly of disengaging the detent 118 by the user so the user can know by tactile feedback what direction the detent 118 is traveling relative to the body 102. For example, to close the distance between the first lens 106a and the second lens 106b can be more difficult than to extend the distance between the first lens 106a and the second lens 106b. In this way, the detent mechanism 101 can provide a noticeable feel and tactile feedback to the user for more precise adjustment of the first lens 106a and the second lens 106b.

The wearable display device 100 can further include an encoder 120. The encoder 120 can be configured to determine a position of the body 102. The encoder 120 can convert motion to an electrical signal that can be read or transmitted to a processor or controller. The encoder can send feedback signals that can be used to determine position, count, speed, or direction. For example, as the body 102 rotates about the pin 116, the encoder 120 can determine the position of the body 102, which can then be correlated to a position of the lenses 106a-b moved according to the rotation of the body 102. In this example, the encoder 120 can determine the position of the body 102 and can communicate the body position to the processor or controller on the wearable display device 100 to display the body position and the width between the first lens 106a and the second lens 106b on the first and second lens 106a, 106b. In this way, in at least one example, the user can easily adjust the first and second lens 106a, 106b via the information provided from the encoder to translate the first and second lens 106a, 106b to a pre-known width.

FIG. 1B illustrates a perspective view of one example of a wearable display device 100 and a detent mechanism 101 in a first position 121. As illustrated in FIG. 1B, the detent 118 in a first detent position 119 engages with the first cavity 110a by extending at least partially into the first cavity 110a. The detent 118 can secure the body 102 in a first body position 103, and the body 102 in a first body position 103 can secure the first rail 108a and the second rail 108b in a first rail position 109. In this way, the first rail 108a and the second rail 108b can translate symmetrically to each other. The first rail 108a and the second rail 108b in the first rail position 109 can secure the first lens 106a and the second lens 106b in a first lens position 107 defined by a first width 122. In this configuration, the detent 118 secures all components such that the first width 122 does close or extend. The first width 122 can only extend or close based on a user input to disengage the detent 118 from the first cavity 110a.

FIG. 1C illustrates a perspective view of one example of a wearable display device 100 and a detent mechanism 101 in a second position 123. In one example, the user can extend the first width 122 by applying a force on the first lens 106a or the second lens 106b to extend the width 122 between the first lens 106a and the second lens 106b. The user force must be enough as to rotate the body 102 about the pin 116 such that the pitch of the first cavity 110a lifts the detent 118 up and translates the detent 118 to the cam surface 112. As discussed in more detail below, the cam surface 112 can be treated such that the force the user applied to overcome the pitch of the first cavity 110a can be slowed by a higher coefficient of friction of the cam surface 112 to ensure the user does not skip over multiple cavities unintentionally and feels the individual cavities interact with the detent 118 as the body 102 rotates during adjustments of the lenses 106a-b. The coefficient of friction referred to in the present disclosure can refer to a coefficient of friction between the referred component and the detent 118, for example the coefficient of friction between the cam surface 112 and the detent 118 can be greater or lower than the coefficient of friction between the cavities 110a-b and the detent 118 such that the cam surface 112 can be referred to as having a higher or lower coefficient of friction than the cavities 110a-b. As the detent 118 can translate or slide in contact with the cam surface 112, the detent 118 can then engage with the second cavity 110b and the detent 118 can then be in a second detent position 117. The detent 118 can secure the body 102 in a second body position 105 and the body 102 in a second body position 105 can secure the first rail 108a and the second rail 108b in a second rail position 111. The first rail 108a and the second rail 108 in the second rail position 111 can secure the first lens 106a and the second lens 106b into a second lens position 125 defined by a second width 124. In this way, although not illustrated, the user can continue to iterate the detent 118 into more cavities defined by the body until the width defined by the lens 106a, 106b positions the lens 106a, 106b in front of the user's eyes, based on the interpupillary distance of the eyes, to deliver an immersive experience. In this way, the user can then reverse the operation to iterate the detent 118 to reduce the width between the lens 106a, 106b.

Any of the features, components, and/or parts, of the rim 360 including the arrangements and configurations thereof shown in FIGS. 1A-1C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 1A-1C.

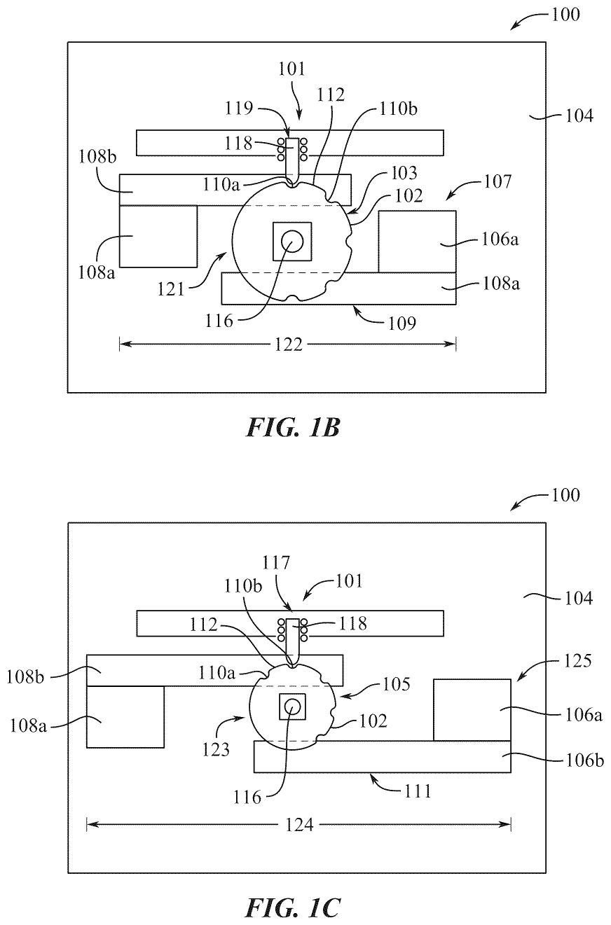

FIG. 2A illustrates a perspective view of one example of a wearable display device 200 and a detent mechanism 201. In one example, the wearable display device 200 can include a display frame 204, a first lens 206a coupled to the display frame 204, a second lens 206b coupled to the display frame 204, and a detent mechanism 201. In at least one example, the detent mechanism 201 can include a body 202, the body 202 can include an outer surface 214, for example a planar surface or a circular surface, defining a first cavity 210a and a second cavity 210b. In such an example, a circumferential surface of the body 202 can extend between the outer surface 214 and another outer surface of the body 202 opposite the outer surface 214 shown to define a thickness or other dimension of the body 202. The detent mechanism 201 can further include a detent 218 configured to engage with at least one of the first cavity 210a or the second cavity 210b. In one example, the detent 218 can be movable into a first detent position and a second detent position, as illustrated in FIGS. 1B and 1C, including the first detent position 119 and the second detent position 117. The detent mechanism 201 can further include a pin 216 coupled to the body 202 such that the body 202 can rotate relative to the pin 216. FIG. 2B illustrates a side view of one example of a detent mechanism 201. As illustrated in FIG. 2B, the detent 218 can be in a first detent position 117 and can be engaged with the first cavity 210a. In this way, the detent 218 can define a protrusion 230 that can define a geometric shape configured to engage with the first cavity 210 and resist or stop the body 202 from rotating about the pin 216. In this way, as the body 202 rotates about the pin 216 so that the edges of the first cavity 210a can push the protrusion 230 of the detent 218 up as to flex the detent 218 up and onto a cam surface such that the body 202 can continue to rotate until the detent 218 secures into the next cavity, such as the second cavity 210b, as illustrated in FIG. 2A.

As illustrated in FIG. 2A, the detent mechanism 201 can include a first rail 208a movably coupled to the body 202, the first rail 208a coupled to the first lens 206a, and a second rail 208b movably coupled to the body 202, the second rail 208b coupled to the second lens 206b. In one example, the first rail 208a and the second rail 208b can be movably coupled to the body 202 via rack and pinions, in such a way that as the body 202 rotates about the pin 216 the rack and pinon can then symmetrically and linearly translate the first rail 208a and the second rail 208b. In this example, as the body 202 rotates the rack and pinion can close or extend a width of the first lens 206a and the second lens 206b, such as the first width 122 and the second width 124 as illustrated in FIGS. 1B and 1C.

In one example, the wearable display device 200 can further include a Hall effect sensor 232, and the Hall effect sensor 232 can be configured to determine the position of the body 202. The body 202 can further include at least a first magnet 234a and a second magnet 234b disposed within a housing 238 of the body 202. In one example, the body 202 can include a one magnet, three magnets, or any suitable number of magnets disposed within the housing 238 of the body 202. As illustrated in FIG. 2A, the body 202 can include a first magnet 234a and a second magnet 234b disposed on opposite ends of the body 202. In this example, as the body 202 rotates about the pin 216, the Hall effect sensor 232 can detect the present of a magnetic field and measure the strength of the magnetic field. A Hall effect sensor 232 can detect the magnetic field and convert the magnetic field into a voltage or otherwise known as Hall voltage and the Hall effect sensor 232 can convert the Hall voltage into an electrical signal. In one example, the electrical signal from the Hall effect sensor 232 can be sent to a processor or a controller to measure or display an output of the position of the body 202 and the corresponding position of the displays or lenses 206a-b.

FIG. 2C illustrates a perspective view of one example of a detent mechanism 201. As illustrated in FIG. 2C, the detent mechanism 201 can be the same detent mechanism 101 as discussed and illustrated in FIG. 1A-1C. In one example, the wearable display device 200 can further include a magnet 234 coupled to the body 202, as discussed above. The wearable display device 200 can further include a magnet array 236 disposed radially about the body 202, the magnetic array 236 configured to determine the position of the body 202. In this way, the magnetic array 236 can work in conjunction with the Hall effect sensor 232 discussed above to determine the magnetic field intensity and therefore the position of the body 202.

Any of the features, components, and/or parts, of the rim 360 including the arrangements and configurations thereof shown in FIGS. 2A-2C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2A-2C.

FIG. 3 illustrates a perspective view of one example of a body 302 of a detent mechanism. The body 302 can define a first cavity 310a and a second cavity 310b radially spaced out about a circumferential surface of the body 302. The body 302 can further define a cam surface 312 between the first cavity 310a and the second cavity 310b. In at least one example, the body 302 can include at least one of a polymer, a carbon-steel, a ceramic, or any other suitable material disposed on or including an outer perimeter surface of the circumferential surface of the body 302. In one example, the body 302 and the first and second cavity 310a, 310b can be a polymer and the detent, such as a detent 118 illustrated in FIG. 1, can be a stainless steel such that the detent 118 sliding along the polymer can give a more distinct feel and feedback to a user. In another example, the detent 118 and the first and second cavities 310a, 310b can be made of a polymer such that as the detent 118 rubs along the surface of the cavities 310a, 310b, it can affect the noise generated by the motion. In at least one example, the cam surface 312 can include a material with a lower coefficient of friction or other material causing a louder noise than the material of the cavities 310a-b and/or body 302 to increase the noise during adjustment and decrease the frictional forces between the detent plunger/ball mechanism and the body 302. Accordingly, the materials of the cavities 310a-b, body 302, and cam surfaces 312 can be selected to tune the tactile feedback and audible feedback given to the user during interpupillary distance adjustments of the displays and lenses described herein.

In one example, the cam surface 312 can be configured to a higher coefficient of friction relative to the first cavity 310a and the second cavity 310b. In another example, the cam surface 312 can include an elastomer material such that the surface can be configured to resist a sliding force between the cam surface 312 and a detent 118. In one example, the cam surface 312 can be surface treated, have a material overmolded over the cam surface 312, material deposited onto the cam surface 312 via physical vapor deposition (VPD), or any other suitable method as to increase the coefficient of friction relative to the first cavity 310a and the second cavity 310b. In some examples, the cam surface 312 can be chemically etched or otherwise etched, for example machine etched, to include etched features affecting the coefficient of friction between the cam surface 312 and a detent. As illustrated in FIG. 3, a material 338 can be deposited over the cam surface 312 to increase the friction of the cam surface 312. The same material and physical features altering the cam surface 312 shown in FIG. 3 and described above can also be applied to the surface between cavities 210a-b shown in the example of FIG. 2A as well as the cam surface 112 shown in the example of FIG. 1A.

In this way, the user can exert a force to disengage a detent 118 from a cavity, for example the first cavity 310a, and the force exerted is to disengage can then cause the detent 118 to translate over the cam surface 312 and skip over to the next/adjacent cavity, for example the second cavity 310b. In this way, the cam surface 312 can be configured to include another materials or surface treatments such that the coefficient of friction is higher relative to the first cavity 310a and the second cavity 310b. In this example, as the user applied force to disengage the detent 118 from the first cavity 310a, the cam surface 312 can resist the sliding of the detent 118 over the body 302 as to ensure the user does not skip over the second cavity 310b due to the force applied to disengage the detent 118.

Any of the features, components, and/or parts, of the rim 360 including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

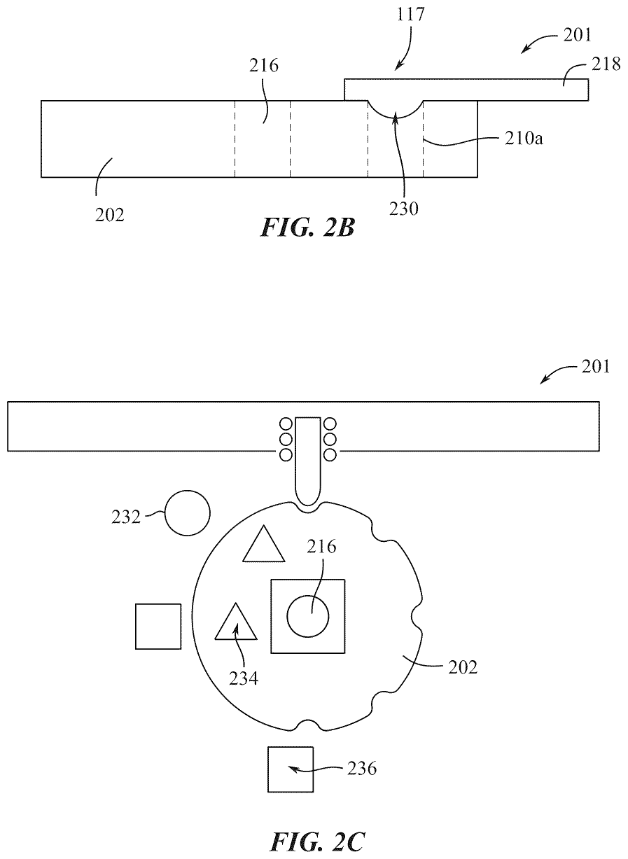

FIGS. 4A, 4B, and 4C illustrates examples of cavities 410 for a detent mechanism 401. As illustrated, a detent 418 can be a roller detent such that detent 418 can include a wheel 419 that can be in contact with the cavities 410. Various examples of the cavities 410 can be configured as different geometric shapes to engage with the detent 418. In one example, the cavities 410 can be configured to be a rounded pin 410a as shown in FIG. 4A. In this example, the wheel 419 of the detent 418 can be engaged between two pins 410a, 410b. In this way, the wheel 419 can be in contact with the two pins 410a, 410b when engaged the cavities 410, delivering a feel and feedback to the user. As the user translates the detent 418, the wheel 419 can be in contact with one pin, for example pin 410b, such that as the wheel 419 then can drop down and engage between two pins again delivering a feel and feedback to the user to indicate the position of the detent 418. In one example, the cavities 410 can be configured to be triangles as shown in FIG. 4B. In this way, the triangle shape of the cavities 410 can provide distinct feedback to the user as the detent 418 travels over the tapered top of the triangle when transitioning from one cavity to a second cavity.

In yet another example, as shown in FIG. 4C, the cavities 410 can define a scallop geometry. In this way, the scallop geometry does not give the feedback of a detent 418 engaging between two rounded pins 410a, 410b shown in FIG. 4A or two triangle pins 410a, 410b shown in FIG. 4C, but seats the wheel 419 in the scallop shape. In this way, the scallop geometry can make the translation of detent 418 easier and provide unique feedback to the user to indicate the iterations of cavities 410.

Any of the features, components, and/or parts, of the rim 360 including the arrangements and configurations thereof shown in FIG. 4A-4C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4A-4C.

FIG. 5 illustrates a perspective view of one example of a detent mechanism 501. As illustrated in FIG. 5, the detent mechanism 501 can include a body 502 and the body 502 can define a linear rail defining a plurality of cavities 510. The detent mechanism 501 can further include a detent 518 configured to engage with the plurality of cavities 510. As illustrated in FIG. 5, the detent 518 can be configured to be a butterfly detent. In this way, as the body 502 or linear rail translates, the edge 542 of the cavities 510 can press down on the top of the detent 518 such that the detent 518 can be pushed down and disengaged, allowing for the body 502 to freely translate. The body can freely translate as a cam surface 512 presses the detent 518 down until the next cavity 510 passes over the top of the detent 518. In this example, as the next cavity 510 passes over the top of the detent 518, the butterfly design allows for the detent 518 to spring up and engage with the next cavity 510.

Any of the features, components, and/or parts, of the rim 360 including the arrangements and configurations thereof shown in FIG. 5 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

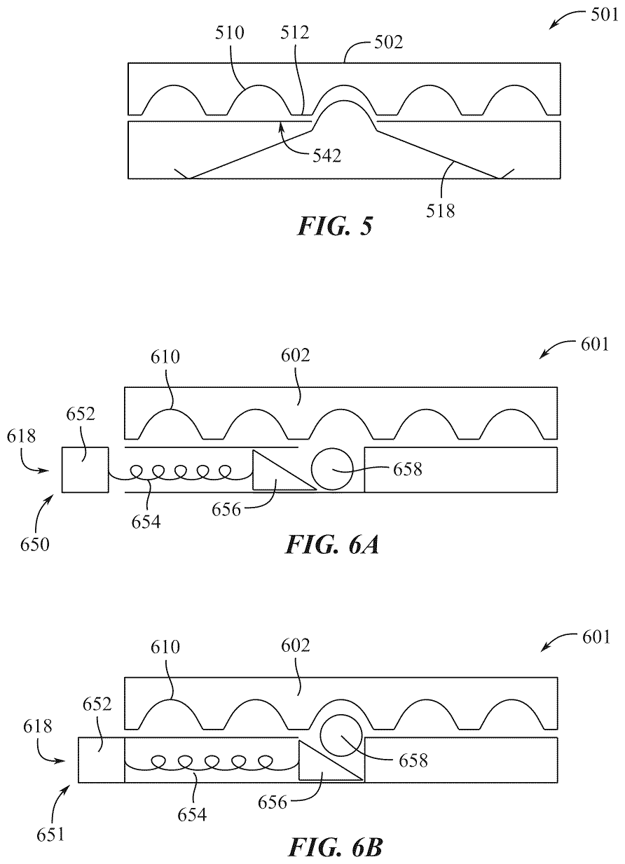

FIG. 6A illustrates a perspective view of one example of a detent mechanism 601 in a first position 650. FIG. 6B illustrates a perspective view of one example of a detent mechanism 601 in a second position 651. The detent mechanism 601 can include a body 602. As illustrated in FIGS. 6A and 6B, the body 602 can be configured to be a linear rail. The detent mechanism 601 can further include a plurality of cavities 610 and a detent 618. The detent 618 can include a guide rod cap 652, a spring 654, a cam 656, and a ball 658. As illustrated in FIG. 6A, the guide rod cap 652 can be in a first position 650 such that the spring 654 is in a relaxed state and the ball 658 is not engaged with one of the plurality of cavities 610. As illustrated in FIG. 6B, the guide rod cap 652 can be in a second position 651 such that the spring 654 is in a compressed state and the spring 654 presses the cam 656 to raise the ball 658 to engage the ball 658 with one of the plurality of cavities 610. In one example, the guide rod cap 652 can be locked into the second position 651 as to keep the ball 658 engaged in the cavity 610. In this example, the guide rod cap 652 can be unlocked as to relax the spring 654 and lower the ball 658 to disengage from the cavity 610 and allow the body 602 to freely translate until engaged again.

Any of the features, components, and/or parts, of the rim 360 including the arrangements and configurations thereof shown in FIGS. 6A-6B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 6A-6B.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A wearable display device, comprising:
a display frame;
a first lens coupled to the display frame;
a second lens coupled to the display frame;
a detent mechanism, comprising:
a body defining a first cavity and a second cavity radially spaced about a circumferential surface of the body; and
a detent configured to engage with at least one of the first cavity or the second cavity;
a first rail movably coupled to the body, the first rail coupled to the first lens; and
a second rail movably coupled to the body, the second rail coupled to the second lens.

2. The wearable display device of claim 1, wherein the body defines a cam surface between the first cavity and the second cavity.

3. The wearable display device of claim 2, wherein the cam surface includes a higher coefficient of friction than the first cavity and the second cavity.

4. The wearable display device of claim 2, wherein the cam surface comprises an elastomer.

5. The wearable display device of claim 1, wherein the body comprises at least one of a polymer, a carbon-steel, or a ceramic.

6. The wearable display device of claim 1, further comprising an encoder configured to determine a body position.

7. The wearable display device of claim 1, further comprising a pin coupled to the body, the body configured to rotate relative to the pin.

8. The wearable display device of claim 1, wherein the first rail and the second rail are configured to translate symmetrically relative to the body.

9. The wearable display device of claim 1, wherein the detent comprises at least one of a spring-loaded ball, a plunger, a roller, or a flexure.

10. The wearable display device of claim 1, wherein the first cavity and the second cavity comprise at least one of a pin, a triangle, or a scallop shape.

11. The wearable display device of claim 1, wherein the first cavity defines an asymmetric profile on the circumferential surface of the body, the asymmetric profile configured to provide varied feedback based on a direction of travel of the body.

12. A wearable display device, comprising:
a display frame;
a first lens coupled to the display frame;
a second lens coupled to the display frame;
a detent mechanism, comprising:
a body including an outer surface defining a first cavity and a second cavity; and
a detent configured to engage with at least one of the first cavity or the second cavity, the detent mechanism movable into a first detent position and a second detent position;
a pin coupled to the body, the body configured to rotate relative to the pin;
a first rail movably coupled to the body, the first rail coupled to the first lens; and
a second rail movably coupled to the body, the second rail coupled to the second lens.

13. The wearable display device of claim 12, wherein:
when the detent is in a first detent position engaged with the first cavity, the detent secures the body in a first body position and the body in the first body position secures the first rail and the second rail in a first rail position;
the first rail and the second rail in the first rail position secures the first lens and the second lens in a first lens position defined by a first width;
when the detent is in a second detent position engaged with the second cavity, the detent secures the body in a second body position and the body in the second body position secures the first rail and the second rail in a second rail position; and
the first rail and the second rail in the second rail position secures the first lens and the second lens in a second lens position defined by a second width.

14. The wearable display device of claim 12, further comprising a magnet coupled to the body.

15. The wearable display device of claim 14, further comprising a magnet array disposed radially about the body, the magnet array configured to be used to determine a position of the body.

16. A wearable display device, comprising:
a display frame;
a lens coupled to the display frame; and
a lens adjustment mechanism, comprising:
a body movably coupled to the lens and defining:
a first cavity;
a second cavity; and
a cam surface extending between the first cavity and the second cavity, the cam surface having to a higher coefficient of friction relative to the first cavity and the second cavity;
a detent configured to engage with at least one of the first cavity, the second cavity, or the cam surface; and
a pin coupled to the body, the body configured to rotate relative to the pin.

17. The wearable display device of claim 16, wherein the cam surface comprises an elastomer material such that the cam surface is configured to increase resistance to a sliding force between the cam surface and the detent relative to the first cavity and the second cavity.

18. The wearable display device of claim 16, wherein the first cavity and the second cavity include a geometry configured to resist the detent from disengaging with the first cavity and the second cavity.

19. The wearable display device of claim 16, further comprising a Hall effect sensor.

20. The wearable display device of claim 19, wherein the Hall effect sensor is configured to determine a position of the body.
